(19) United States
(12) Patent Application Publication
(10) Pub. No.: US 2006/0064707 A1
(43) Pub. Date: Mar. 23, 2006

(54) Slot-loading optical drive structure

(76) Inventors: Min-Cheng Yang, Lungching Township (TW); Jen-Chieh Cheng, Taan Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/967,132

(22) Filed: Oct. 19, 2004

(30) Foreign Application Priority Data
Aug. 31, 2004 (TW) 093213817

(51) Int. Cl. G11B 17/04

(52) U.S. Cl. 720/623

(57) ABSTRACT

A slot-loading optical drive structure is proposed. It includes a base with a gearing for driving a sliding body to move a sliding plate. The sliding plate has a positioning slot for guiding a push rod to push an optical disc into the optical drive. Thereby, a positioning rod can presses one side of the optical disc, the push rod can presses the back end of the optical disc, and a rod connection means can presses the front end of the optical disc. Hence the optical disc can be positioned at a fixed location to make the central hole of the optical disc correctly aligned to the center of the turntable of the traverse inside the optical drive. Thus, the optical disc can be settled on the turntable and the optical drive can rotate the optical disc for data access.

### BACKGROUND OF THE INVENTION

1. Field of the Invention

The present invention is related to a slot-loading optical drive structure, and more particularly, to a slot-loading optical drive that is able to make the central hole of an optical disc correctly aligned to the center of the turntable of the traverse inside. Thereby, the slot-loading optical drive can correctly load the optical disc and rotate it for data access.

2. Description of Related Art

Due to the progress of science and technologies, the manufacture techniques for optical discs are also improved greatly. Hence, the optical discs have a high quality and various advantages in the present. For example, the optical discs are able to preserve the data recorded inside for a very long time period, have a large storage capacity and can be easily carried.

Nowadays, the optical discs have been extensively used to backup electronic files, especially to backup video files. In this way, information exchange between people can be enhanced. Besides, after work, the people can comfortably see a movie or listen to music at home by using the optical discs for relaxation or fun.

Conventionally, most of the optical drives for data access of optical discs have a disc tray. The optical drives use the disc tray to carry an optical disc for data access. However, during putting an optical disc on the disc tray of the optical drive, the optical disc may be put at an erroneous position so that it may be jammed in the optical drive. Besides, after taking out the optical disc, a user may forget to make the disc tray back into the optical drive so that the disc tray may be broken carelessly.

In order to solve these problems, slot-loading optical drives have been introduced into the market recently. This kind of optical drives doesn't need the disc tray. A user can directly insert an optical disc into the slot-loading optical drive and then the mechanism inside the slot-loading optical drive would automatically receive and load the optical disc. However, the present slot-loading optical drives have a problem that they are usually not able to make the central hole of an optical disc correctly aligned to the center of the turntable of the traverse inside. It causes the slot-loading optical drives not able to rotate the optical disc to access the data recoded therein.

Therefore, the present invention provides a slot-loading optical drive structure that can make the central hole of an optical disc correctly aligned to the center of the turntable of the traverse inside so as to resolve the drawback mentioned above.

### SUMMARY OF THE INVENTION

An objective of the present invention is to provide a slot-loading optical drive structure. Via cooperation of a push rod, a rod connection means and a positioning rod, when an optical disc is inserted, the slot-loading optical drive structure of the present invention can correctly position the optical disc to a fixed position so that the optical disc can be settled on a turntable and then the optical drive structure can rotate the optical disc to access the data recorded thereon.

Another objective of the present invention is to provide a slot-loading optical drive structure. During ejection of the optical disc, the present invention uses a simple rod connection means to push the optical disc out from the slot-loading optical drive structure.

Still another objective of the present invention is to provide a slot-loading optical drive structure that can prevent disc jamming caused by inserting an optical disc that doesn't conform to the disc standard of the present invention.

For achieving the objectives above, the present invention provides a slot-loading optical drive structure, including a base with a gearing, a sliding body, a sliding plate, a push rod, a positioning rod and a rod connection means. When an optical disc is inserted, the gearing drives the sliding body to move. Since the sliding plate is fixedly disposed at the lower end of the sliding body, the sliding plate is moved together with the sliding body. The push rod located below the sliding plate is driven by the sliding plate to push the back end of the optical disc until the optical disc is completely inserted into the slot-loading optical drive structure. After that, one side of the optical disc contacts the positioning rod located at one side of the base and thereby the positioning rod can position the optical disc at a fixed location. Besides, during the insertion of the optical disc, the rod connection means keeps pressing the front end of the optical disc. Thus, the optical disc can be positioned at the fixed location to make the central hole of the optical disc correctly aligned to the center of the turntable of the traverse inside the slot-loading optical drive structure. Thereby, the optical disc can be settled on the turntable and the slot-loading optical drive structure can rotate the optical disc for data access. In addition, during ejection of the optical disc, the gearing drives the sliding body toward opposite direction to make the rod connection means push the optical disc out from the lot-loading optical drive structure.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a combinative diagram of a preferred embodiment in accordance with the present invention;

FIG. 2 is an exploded diagram of the preferred embodiment in accordance with the present invention;

FIGS. 3-7 are diagrams for illustrating the operation of accessing the data recorded on the optical disc in accordance with the present invention.

### DETAILED DESCRIPTION OF PREFERRED EMBODIMENTS

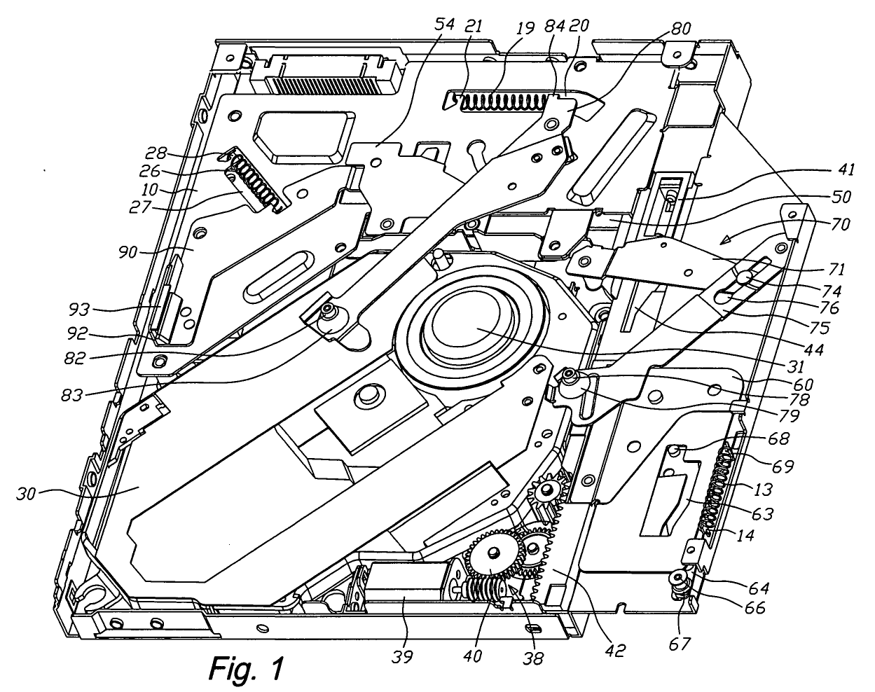

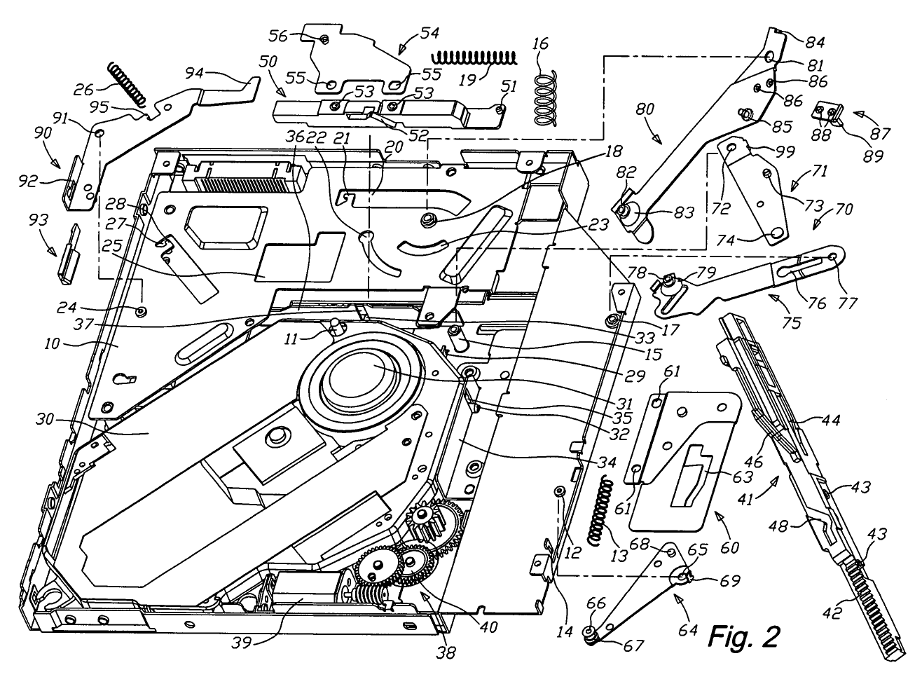

Reference is made to FIGS. 1-2, which are combinative and exploded diagrams of a preferred embodiment in accordance with the present invention. As shown in the figures, the present invention includes a base 10 having a traverse 30 disposed thereon. The traverse 30 has a turntable 31, which is used to carry and rotate an optical disc for data access. Furthermore, the two sides of the front end of the traverse 30 have hoist poles 32, 33, respectively. The bottom of the base 10 has a gearing 38 disposed thereon, in which the gearing has a motor 39 to drive a set of gears 40 and thereby drive a sliding body 41 of the base 10 to move upward or downward. The sliding body 41 is moved due to the cooperation of a rack 42 at its lower end and the gears 40. Besides, the upper end of the sliding body 41 has a position-limited trough 44 and a sidelong-shifted trough 46. A first hoist trough 48, which is an oblique trough, is disposed between the sidelong-shifted trough 46 and the rack 42.

A sidelong-shifted body 50 has one end with a sidelong-shifted pole 51 disposed within the sidelong-shifted trough 46 of the sliding body 41. One side of the sidelong-shifted body 50 has a second hoist trough 52 disposed thereon, in which the second hoist trough 52 is also an oblique trough. The hoist poles 32, 33 of the traverse 30 are disposed within the first hoist trough 48 and the second hoist trough 52 respectively. When the gearing 38 drives the sliding body 41 to move upward, the sidelong-shifted trough 46 can make the sidelong-shifted body 50 move toward the sliding body 41 because the sidelong-shifted trough 46 has a slope. At this moment, the first hoist trough 48 and the second hoist trough 52 can make the hoist poles 32, 33 move upward and thereby make the traverse 30 move upward. Thus, the traverse 30 can drive the turntable 31 to carry the optical disc, whose central hole is aligned to the center of the turntable 30.

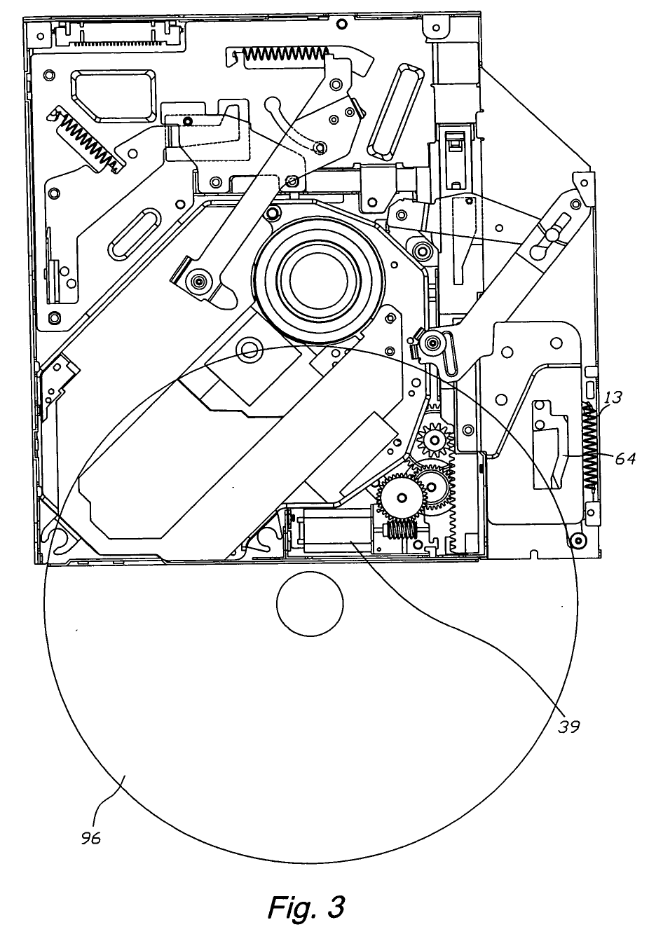

Subsequently, since both the first hoist trough 48 and the second hoist trough 52 have a downward oblique trough at their ends, the traverse 30 would be driven to move downward. Thus, the traverse 30 can rotate the optical disc to access the data recorded thereon. The steps mentioned above are a part of the operation for data access. The detailed steps for aligning the central hole of the optical disc to the center of the turntable will be illustrated in FIGS. 3-7. Similarly, when the optical disc should be ejected, the motor rotates backward to make the sliding body 41 move downward and thereby make the sidelong-shifted body 50 leave the sliding body 41. Thus, the traverse 30 is moved downward and thereby the optical disc can be pushed apart from the traverse 30 by a projective pole 11. Besides, in order to prevent the traverse 30 from sway during moving upward or downward, position-limited plates 34, 36 are disposed on the base 10 located in front of the hoist poles 32, 33, respectively. The position-limited plates 34, 36 respectively have oblong slots 35, 37 to limit the hoist poles 32, 33 to upward or downward movement.

A sliding plate 60 is fixedly disposed at the lower end of the sliding body 41 via fixed holes 61 together with fixed poles 43 at the lower end of the sliding body 41. The sliding plate 60 has a positioning slot 63. The base 10 below the sliding plate 60 has a push rod 64, which is disposed at the base 10 via a through hole 65 together with a projective pole 12 of the base 10. The push rod 64 has a push axle 66 and positioning pole 68. The push axle 66 has a push body 67 slipped thereon for pushing the optical disc. The positioning pole 68 is disposed inside the positioning slot 63. Thus, when the sliding plate 60 moves, the positioning slot 63 can control the movement of the push rod 64. Therein, the push rod 64 further has a crook block 69 to hook one end of an elastic component 13, whose another end is hooked by a crook block 14 disposed on the base 10.

A rod connection means 70 includes a first connecting rod 71 and a second connecting rod 75. One end of the first connecting rod 71 has a through hole 72 for slipping on a fixed axle 15 of the base 10. Before the first connecting rod 72 is slipped on the fixed axle 15, an elastic component 16 is slipped on the fixed axle 15 in advance. The two ends of the elastic component 16 are respectively hooked on a crook block 29 of the base 10 and a crook block 99 disposed on the lower surface of the first connecting rod 71. The lower surface of the first connecting rod 71 further has a position-limited pole 73, which is disposed within the position-limited trough 44 of the sliding body 41. Thereby, the first connecting rod 71 can be controlled via the movement of the sliding body 41. The first connecting rod 71 further has a guiding pole 74, which is disposed within a guiding slot 76 of the second connecting rod 75. The second connecting rod 75 has a through hole 77 to slip on a projective pole 17 of the base 10. The second connecting rod 75 further has a push axle 78, which has a push block 79 slipped thereon, to push the optical disc.

A separate plate 54 is fixedly disposed on the sidelong-shifted body 50 via two fixed holes 55 together with two fixed poles 53 of the sidelong-shifted body 50. The upper end of the separate plate 54 has a separate pole 56. An activation rod 80 is disposed at the upper end of the base 10 via a through hole 81 defined thereon and a projective pole 18 at the upper end of the base 10. One end of the activation rod 80 has a push axle 82, which has a push body 83 slipped thereon to contact and press the optical disc. The upper end of the activation rod 80 has a crook block 84 to hook one end of an elastic component 19, which is disposed within a containing trough 20 of the base 10. The other end of the elastic component 19 is hooked by a crook block 21 of the containing trough 20. The upper end of the activation rod 80 further has a push pole 85, which is disposed within an arc trough 22 of the base 10. When the separate plate 54 is moved, it will contact and push the push pole 85 so as to force the activation rod 80 to move. The upper end of the activation rod 80 further has two fixed holes 86 to slip on two fixed poles 88 of an activation block 87 and thereby fix the activation block 87. The bottom of the activation block 87 has an activation pole 89, which is disposed within an activation trough 23 of the base 10 to turn on a switch to activate the motor 39 of the gearing 38.

A positioning rod 90 is disposed on the baser 10 via a through hole 91 disposed thereon and a projective pole 24 of the base 10. The lower end of the positioning rod 90 has a fixing plate 92, which has a positioning block 93 to position the optical disc at a predetermined location when the optical disc is inserted into the optical drive. The frond end of the positioning rod 90 has an oblique plate 94, which is disposed within a containing trough 25 of the base 10. When the sidelong-shifted body 50 drives the separate plate 54 to move, the separate pole 56 will drive the oblique plate 94 and thereby make the positioning rod 90 move to a predetermined location. The positioning rod 90 further has a crook block 95 to hook one end of an elastic component 26, which is disposed within a containing trough 27 of the base 10. The other end of the elastic component 26 is hooked on a crook block 28 of the containing trough 27.

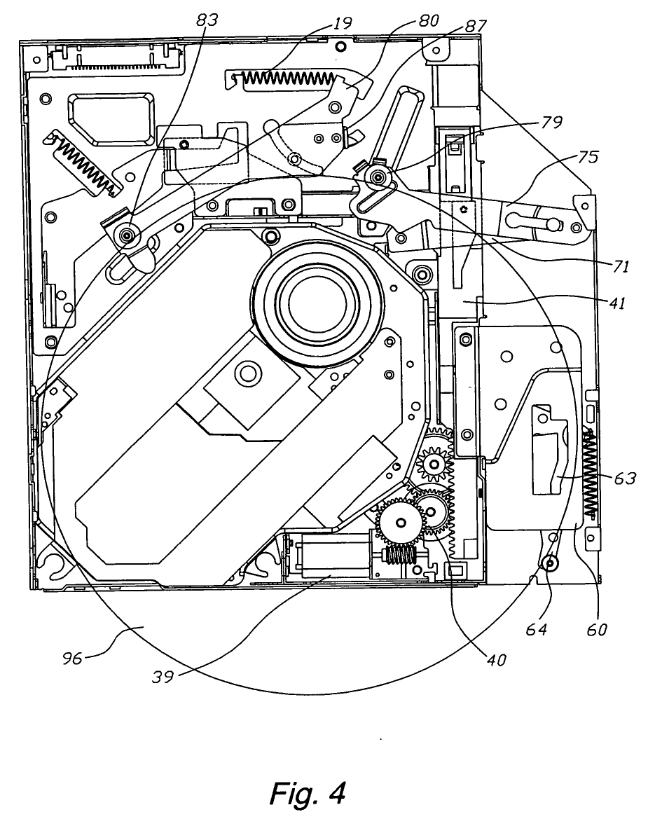

Reference is made to FIGS. 3-7, which are diagrams for illustrating the operation of accessing the data recorded on the optical disc in accordance with the present invention. FIG. 3 shows an initial state before accessing the data of the optical disc in the present invention. At this state, the motor 39 is static and not activated. When a user inserts the optical disc 96 into the optical drive of the present invention, since the push rod 64 is pulled toward the clockwise direction by the elastic component 13, the push body 67 can keep contacting with the optical disc 96. As shown in FIG. 4, when the user continues to push the optical disc 96, the optical disc 96 pushes the push block 79 of the second connecting rod 75 and the push body 83 of the activation rod 80. That makes the activation rod 80 rotate and thereby moves the activation block 87. Thus, the activation pole 89 of the activation block 87 can turn on the activating switch so that the motor 39 can be activated.

When the motor 39 is activated, it drives the gears 40 to rotate and thereby makes the sliding body 41 move upward. At this time, the positioning slot 63 of the sliding plate 60 guides the push rod 64 to move so as to push the optical disc 96 into the optical drive. Due to the elasticity of the elastic component 16 below the first connecting rod 71 (toward the clockwise direction), the first connecting rod 71 makes the second connecting rod 75 move toward the counterclockwise direction and makes the push block 79 push the right front end of the optical disc 96. Besides, due to the elasticity of the elastic component 19 (toward the counterclockwise direction), the activation rod 80 rotates in the counterclockwise direction and thereby makes the push body 83 push the left front end of the optical disc 96.

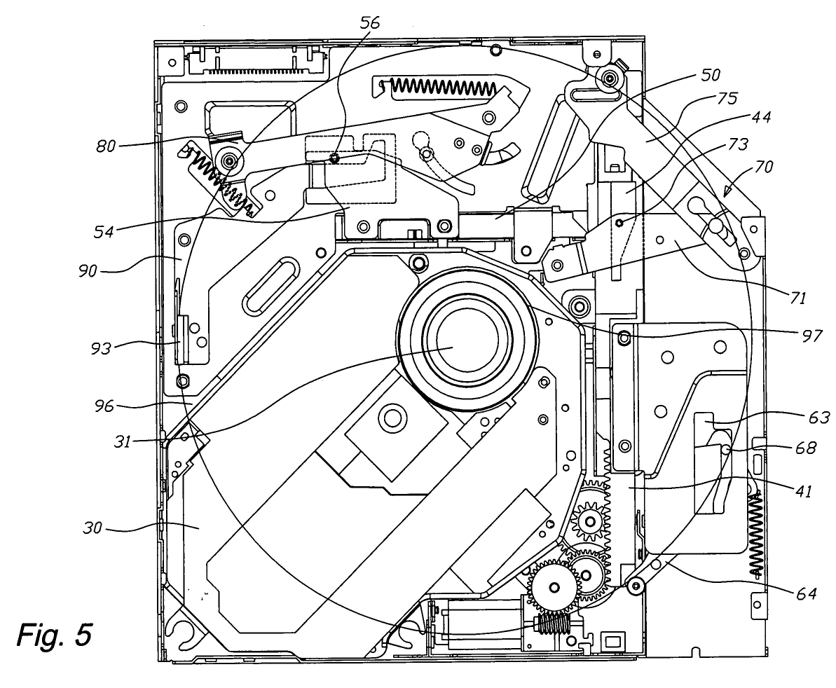

As shown in FIG. 5, when the push rod 64 completely pushes the optical disc 96 into the optical disc, the positioning block 93 of the positioning rod 90 can position the left end of the optical disc 96 to a fixed location and the push rod 64 can position the back end of the optical disc 96. Using the rod connection means 70 and the activation rod 80 to push the front end of the optical disc 96 can position the position the optical disc 96 to a fixed location so that the central hole 97 of the optical disc 96 can be correctly aligned to the center of the turntable 31 of the traverse 30. At this moment, the sliding body 41 keeps moving upward and the sidelong-shifted pole 51 of the sidelong-shifted body 50 is moved to the lower portion of the sidelong-shifted trough 46 of the sliding body 41 so that the sidelong-shifted body 50 is moved toward the sliding body 41. Then, the hoist poles 32, 33 are guided by the first hoist trough 48 and the second hoist trough 52 to move upward and thereby the traverse 30 is move upward. At this moment, the optical disc 96 is pressed by the upper cover of the optical drive and the turntable 31. Hence, the optical disc 96 can be settled on the turntable 31. After that, since the last portions of the first hoist trough 48 and the second hoist trough 52 is a downward oblique trough, the traverse 31 is moved downward and then the optical drive can rotate the optical disc 96 to access the data recorded thereon.

When the sliding body 41 is moved upward to push the optical disc 96 into the optical drive, since the positioning pole 68 of the push rod 64 is moved to the direct portion of the positioning slot 63, the position of the push rod 64 is fixed. Moreover, since the position-limited pole 73 of the first connecting rod 71 is also moved to the direct portion of the position-limited trough 44, the position of the second connecting rod 75 is fixed, too. In addition, when the sidelong-shifted body 50 is moved sidelong, since the first portion of the positioning rod 90 has a direct shape, the separate pole 56 of the separate plate 54 doesn't make the positioning rod 90 leave its original position.

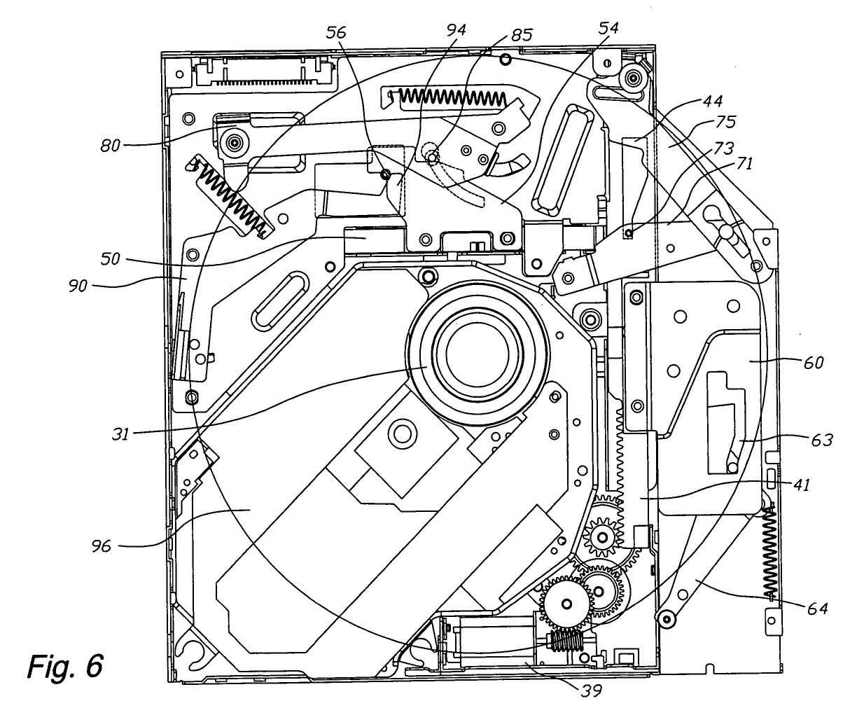

Before accessing the data recorded on the optical disc 96, the push rod 64, the second connecting rod 75, the activation rod 80 and the positioning rod 90 should be moved away from the optical disc 96 to prevent the optical disc 96 from being scraped. As shown in FIG. 6, in order to reach this objective, the sliding body 41 is still moved upward so that the sliding plate 60 is also moved upward. Thereby, the last portion of the positioning slot 63 can makes the push rod 64 leave from the back end of the optical disc 96. Furthermore, the last portion of the position-limited trough 44 of the sliding body 41 guides the position-limited pole 73 of the first connecting rod 71 so that the second connecting rod 75 is moved to leave from the right front end of the optical disc 96. In addition, since the sidelong-shifted body 50 is kept moving toward the sliding body 41, the separate plate 54 is also moved in the right direction. By using the front end of the separate plate 54 to push the push pole 85 of the activation rod 80, the activation rod 80 is moved to leave from the optical disc 96. At the same time, using the separate pole 56 of the separate plate 54 to pull the oblique plate 94 of the positioning rod 90 can make the positioning rod 90 leave from the optical disc 96. Then, the sliding body 41 turns off the activating switch to stop the motor 39 from rotation. Thus, the optical drive can rotate the optical disc 96 via the turntable 31 to access the data recorded on the optical disc 96.

When the data of the optical disc 96 is accessed and the user wants to eject the optical disc 96, the user can press the ejecting button to activate the motor 39 and make it rotate backward. Then, the motor 39 drives the sliding body 41 to move downward. At this time, the hoist poles 32, 33 are guided by the first hoist trough 48 and the second hoist trough 52 to move upward first and then downward. This action is opposite to that pushing the optical disc 96 into the optical drive. Thereby, the projective pole 11 can make the optical disc 96 be pushed out from the turntable 31. Then, the second connecting rod 75 of the rod connection means 70 can push the optical disc 96 downward and thereby push the optical disc 96 out from the optical drive.

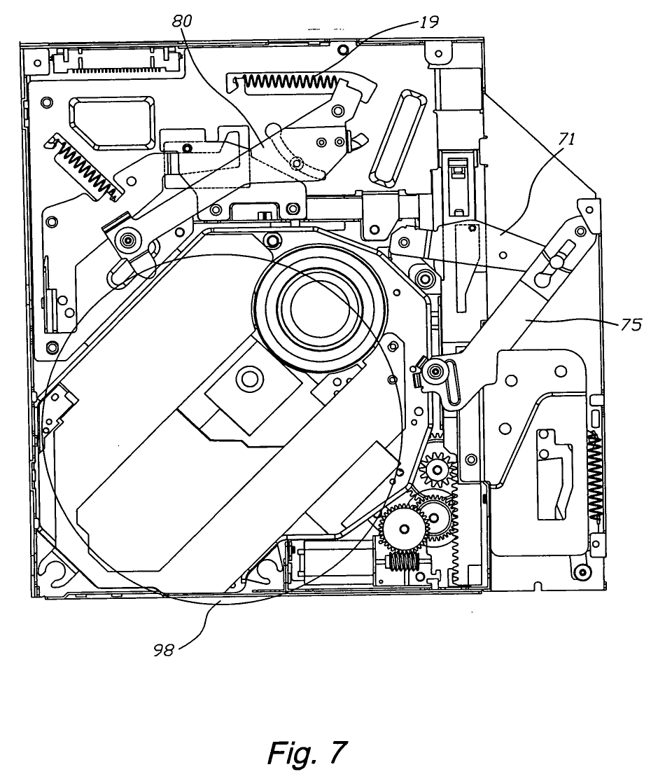

As shown in FIG. 7, in order to prevent the problem caused by that the user inserts the optical disc with a smaller size, for example the optical disc with 8 cm diameter, the position of the activation rod 80 designed in the present invention makes the optical disc 98 unable to push the activation rod 80, i.e. unable to turn on the activating switch, in case that the optical disc 98 is inserted into the left side of the optical drive. Thus, the optical drive will not proceed the following actions for accessing the optical disc 98. Thereby, the present invention can prevent the optical disc 98 from be jammed inside the optical drive. Besides, due to the elasticity of the elastic component 19, the activation rod 80 can push the optical disc 98 out from the optical drive automatically.

Furthermore, in case that the optical disc 98 is inserted into the right side of the optical drive, the optical disc 98 will push the second connecting rod 75. Due to the elasticity of the elastic component 16 disposed below the first connecting rod 71, the second connecting rod 75 will rotate counterclockwise and push the optical disc 98 out from the optical drive automatically. Thereby, the present invention can prevent the optical disc 98 from be jammed inside the optical drive.

Summing up, when a user inserts the optical disc 96 into the optical disc, via the cooperation of the push rod 64, the rod connection means 70 and the positioning rod 90, the slot-loading optical drive structure of the present invention can correctly position the optical disc 96 to a fixed position so that the optical disc 96 can be settled on the turntable 31 and then the optical drive structure can rotate the optical disc 96 to access the data recorded thereon. In addition, when the optical disc 96 is ejected, using the simple rod connection means 70 can push the optical disc 96 out from the optical drive.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

What is claimed is:

1. A slot-loading optical drive structure, used to position an optical disc at a predetermined location, the slot-loading optical drive structure comprising:
a base;
a sliding body disposed on the base and capable of moving upward or downward;
a gearing disposed on the base and capable of driving the sliding body to move;
a sliding plate disposed at a lower end of the sliding body;
a push rod disposed on the base and guided by the sliding plate;
a rod connection means disposed at a upper end of the base and used to press the optical disc during position alignment of the optical disc after the optical disc is inserted into the slot-loading optical drive structure; and
a positioning rod disposed at a side of the base opposite to the sliding body, the positioning rod used to position the optical disc at the predetermined location;
wherein, when the optical disc is inserted into the slot-loading optical drive structure, the sliding body is moved upward and thereby makes the sliding plate move upward together so that the push rod is guided to further push the optical disc into the slot-loading optical drive structure and make one side of the optical disc contact with the positioning rod, the push rod presses a lower end of the optical disc and the rod connection means presses a upper end of the optical disc to align a central hole of the optical disc to a center of a turntable of a traverse disposed on the base, thereby the optical disc can be settled on the turntable and the slot-loading optical drive structure can rotate the optical disc for data access.

2. The slot-loading optical drive structure as claimed in claim 1, further comprising:
an activation rod disposed at the upper end of the base, wherein, when the optical disc is inserted into the slot-loading optical drive structure, the optical disc pushes the activation rod to turn on an activating switch to activate the gearing.

3. The slot-loading optical drive structure as claimed in claim 1, wherein a lower end of the sliding body has a rack, the gearing has a motor and a set of gears, the motor driving the gears and thereby driving the rack to move the sliding body.

4. The slot-loading optical drive structure as claimed in claim 1, wherein sliding plate has a positioning slot, the push rod has a positioning pole disposed within the positioning slot, the positioning slot guides the push rod to push the optical disc for the position alignment.

5. The slot-loading optical drive structure as claimed in claim 4, wherein, after the position alignment is performed, the sliding body keeps moving upward and thereby makes the sliding plate move upward together so that the positioning slot guides the positioning pole to make the push rod leave away from the optical disc.

6. The slot-loading optical drive structure as claimed in claim 1, wherein the push rod hooks one end of an elastic component, whose another end is hooked on the base.

7. The slot-loading optical drive structure as claimed in claim 1, wherein the rod connection means includes a first connecting rod and a second connecting rod, the first connecting rod has one end disposed on the base and hooking one end of an elastic component, whose another end is hooked on the base, the first connecting rod is located above a upper end of the sliding body, the first connecting rod has another end disposed within a guiding slot of the second connecting rod, the second connecting rod has one end disposed on the base, the first connecting rod drives the second connecting rod to make another end of the second connecting rod press the optical disc during the position alignment.

8. The slot-loading optical drive structure as claimed in claim 7, wherein the first connecting rod has a position-limited pole, which is disposed within a position-limited trough defined at the upper end of the sliding body; after the position alignment is performed, the sliding body keeps moving upward so that the position-limited trough guides the position-limited pole to make the first connecting rod move and thereby drive the second connecting rod to leave from the optical disc.

9. The slot-loading optical drive structure as claimed in claim 1, wherein the sliding body has a upper end with a sidelong-shifted trough, one end of a sidelong-shifted means is disposed within the sidelong-shifted trough, the sidelong-shifted means is driven to move toward the sliding body when the sliding body is moved upward; after the position alignment is performed, the sliding body keeps moving upward to drive the sidelong-shifted means to move and thereby drive the positioning rod to leave from the optical disc.

10. The slot-loading optical drive structure as claimed in claim 9, wherein the sidelong-shifted means has a sidelong-shifted body, whose one end has a sidelong-shifted pole disposed within the sidelong-shifted trough, the sidelong-shifted body has a separate plate disposed thereon and a surface of the separate plate has a separate pole; after the position alignment is performed, the separate plate of the sidelong-shifted means drives a oblique plate disposed at one end of the positioning rod to make the positioning rod leave from the optical disc.

11. The slot-loading optical drive structure as claimed in claim 1, wherein the positioning rod has one end hooking one end of an elastic component, whose another end is hooked on the base.

12. The slot-loading optical drive structure as claimed in claim 1, further comprising:
an activation rod having one end disposed on the base and hooking one end of an elastic component, whose another end is hooked on the base, the activation rod pressing the optical disc during the position alignment.

13. The slot-loading optical drive structure as claimed in claim 12, wherein, after the position alignment is performed, the sliding body keeps moving upward and thereby drives a sidelong-shifted means disposed beside a upper end of the sliding body to move toward the sliding body, the sidelong-shifted means drives the activation rod to leave from the optical disc, the upper end of the sliding body has a sidelong-shifted trough, the sidelong-shifted means has one end disposed within the sidelong-shifted trough and capable of moving within the sidelong-shifted trough.

14. The slot-loading optical drive structure as claimed in claim 13, wherein the sidelong-shifted means has a sidelong-shifted body, whose one end has a sidelong-shifted pole disposed within the sidelong-shifted trough, the sidelong-shifted body has a separate plate disposed thereon; after the position alignment is performed, the separate plate of the sidelong-shifted means drives a push pole disposed on the activation rod to make the activation rod leave from the optical disc.

15. The slot-loading optical drive structure as claimed in claim 1, wherein the sliding body has a sidelong-shifted trough and a first hoist trough, the sidelong-shifted trough has a sidelong-shifted pole of a sidelong-shifted body disposed therein, the sidelong-shifted body has a second hoist trough, the traverse has a front end with two sides each having a hoist pole, the hoist poles of the two sides of the traverse are respectively disposed within the first hoist trough and the second hoist trough; during the position alignment, the sliding body is moved upward and thereby drives the sidelong-shifted body to move toward the sliding body, the first hoist trough and the second hoist trough guide the hoist poles to move upward and thereby move the traverse upward to settle the optical disc on the turntable.

16. The slot-loading optical drive structure as claimed in claim 1, wherein the positioning rod has a lower end with a positioning block, which is used to position the optical disc at the predetermined location.

17. A slot-loading optical drive structure, used to eject an optical disc, the slot-loading optical drive structure comprising:
a base;
a sliding body disposed on the base and capable of moving upward or downward;
a gearing disposed on the base and capable of driving the sliding body to move;
a first connecting rod disposed on the base and located above a upper end of the sliding body; and
a second connecting rod disposed on the base, the second connecting rod having a guiding slot, the first connecting rod having one end disposed within the guiding slot;
wherein, during ejection of the optical disc, the sliding body is moved downward to drive the first connecting rod to move and thereby drive the second connecting rod to push the optical disc so that the optical disc is moved downward for ejection.

18. The slot-loading optical drive structure as claimed in claim 17, wherein the sliding body has a lower end with a rack, the gearing includes a motor, a set of gears, the motor drives the gears and thereby drives the rack to move the sliding body.

19. The slot-loading optical drive structure as claimed in claim 17, wherein the end of the first connecting rod disposed within the guiding slot has a guiding pole, the guiding pole is disposed within the guiding slot, the first connecting rod has a lower end with a position-limited pole, the position-limited pole is disposed within a position-limited trough defined at the upper end of the sliding body; when the sliding body is moved downward, the position-limited trough drives the position-limited pole to move the first connecting rod and thereby move the second connecting rod.

20. The slot-loading optical drive structure as claimed in claim 17, wherein the first connecting rod hooks one end of an elastic component, whose another end is hooked on the base.

21. The slot-loading optical drive structure as claimed in claim 17, wherein the sliding body has a sidelong-shifted trough and a first hoist trough, the sidelong-shifted trough has a sidelong-shifted pole of a sidelong-shifted body disposed therein, the sidelong-shifted body has a second hoist trough, a traverse inside the slot-loading optical drive structure has a front end with two sides each having a hoist pole, the hoist poles of the two sides of the traverse are respectively disposed within the first hoist trough and the second hoist trough; during ejection of the optical disc, the sliding body is moved downward to drive the first connecting rod to move and thereby drive the sidelong-shifted body to leave the sliding body, the first hoist trough and the second hoist trough guide the hoist poles to move downward and thereby move the traverse downward together so that the optical disc is pushed out from a turntable of the traverse via a projective pole.
